(19) United States
(12) Patent Application Publication
(10) Pub. No.: US 2005/0202316 A1
(43) Pub. Date: Sep. 15, 2005

(54) Lithium secondary battery

(76) Inventors: Duck-Chul Hwang, Suwon-si (KR); Geun-Bae Kim, Suwon-si (KR); Yong-Chul Park, Suwon-si (KR); Won-Il Jung, Suwon-si (KR); Jun-Won Suh, Suwon-si (KR); Jan-Dee Kim, Suwon-si (KR)

Correspondence Address: CHRISTIE, PARKER & HALE, LLP, PO BOX 7068, PASADENA, CA, 91109-7068, US

(21) Appl. No.: 11/078,542

(22) Filed: Mar. 11, 2005

(30) Foreign Application Priority Data
Mar. 12, 2004 (KR) 10-2004-0016814

(51) Int. Cl. H01M 4/50; H01M 4/52; H01M 4/58

(52) U.S. Cl. 429/231.1; 429/223; 429/224; 429/231.3; 429/231.6; 429/221; 429/231.5; 429/5; 429/220; 429/229; 429/219; 429/231.8

(57) ABSTRACT

Disclosed is a lithium secondary battery including a positive electrode comprising a combination of positive active materials. The combination includes a material represented by one or both of Formulae 1 and 2; and a material of Formula 3 as follows:
LiₐNi_{b}Mn_{c}M_{d}O₂ (Formula 1) where 0.90≦a≦1.2; 0.5≦b≦0.9; 0<c<0.4; 0≦d≦0.2;
LiₐNi_{b}Co_{c}Mn_{d}MₑO₂ (Formula 2) where 0.90≦a≦1.2, 0.5≦b≦0.9, 0<c<0.4, 0<d<0.4, and 0≦e≦0.2;
LiₐCoM_{b}O₂ (Formula 3) where 0.90≦a≦1.2 and 0≦b≦0.2; and each M of Formulae 1-3 is independently selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, Po, and combinations.

### CROSS REFERENCE TO RELATED APPLICATION

This application claims priority to and the benefit of Korean Patent Application No. 10-2004-0016814 filed in the Korean Intellectual Property Office on Mar. 12, 2004, the entire disclosure of which is incorporated herein by reference.

### FIELD OF THE INVENTION

The present invention relates to a lithium secondary battery, and more particularly to a lithium secondary battery with improved cycle life at room temperature and high temperatures and with enhanced safety.

### BACKGROUND OF THE INVENTION

A recently developed lithium secondary battery using organic electrolyte has high energy density characteristics to the extent that its discharge voltage is more than twice as high as that of a conventional battery using an alkali aqueous solution, and its use is gaining more momentum as a power source for portable compact electronic equipment as the use of such electronic equipment increases.

A lithium secondary battery mainly uses lithiated intercalation compounds including lithium and transition metals such as LiCoO₂, LiMn₂O₄, and LiNi₁₋ₓCoₓO₂ (where 0<x<1), which are capable of intercalating lithium ions as a positive active material.

However, as electronic equipment becomes smaller and their use increases, research into a battery with a higher energy density and higher capacity is required. Accordingly, much research on new active materials formed by mixing various active materials, each with at least one advantage, has been performed to develop a battery to meet all advantageous criteria such as high capacity, low cost, etc., but most of the results have turned out unsatisfactorily, leaving many challenges for future research.

### SUMMARY OF THE INVENTION

According to one embodiment of the present invention, a lithium secondary battery is provided with the characteristics of improved cycle life at room temperature and high temperatures, and with enhanced safety. The battery uses a positive electrode including an appropriate mixture of more than one positive active material.

According to another embodiment of the invention, a lithium secondary battery is provided including a positive electrode which includes a first positive active material represented by either or both of Formula 1 and Formula 2 and a second positive active material represented by Formula 3, a negative electrode which includes a negative active material, and an electrolyte.
LiₐNi_{b}Mn_{c}M_{d}O₂ (1)
where 0.90≦a≦1.2; 0.5≦b≦0.9; 0<c<0.4; and 0≦d≦0.2; and M is at least element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po.
LiₐNi_{b}Co_{c}Mn_{d1}MₑO₂ (2)
where 0.90≦a≦1.2; 0.5≦b≦0.9; 0<c<0.4; 0<d1<0.4; and 0≦e≦0.2; and M is at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po,
LiₐCoM_{b1}O₂ (3)
where 0.90≦a≦1.2 and 0≦b1≦0.2; and M is at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a schematic view illustrating a lithium secondary battery according to one embodiment of the present invention;

FIG. 2 is a drawing of a sampled part of a positive electrode used to analyze the positive electrode of a lithium secondary battery of the present invention;

FIG. 3 is a SEM picture of the first positive active material in the positive electrode of Example 12 according to the present invention;

FIGS. 4 and 5 are graphs showing the results of EDX analysis of the first positive active material measured after formation-standard charging a lithium secondary battery fabricated by using the positive electrode of Example 12 according to the present invention;

FIG. 6 is a SEM picture of the second positive active material at the positive electrode of Example 12 according to the present invention; and

FIGS. 7 and 8 are graphs showing the results of EDX analysis of the second positive active material measured after formation-standard charging a lithium secondary battery fabricated by using the positive electrode of Example 12 according to the present invention.

### DETAILED DESCRIPTION

The present invention provides a lithium secondary battery that uses a mixture of more than one positive active material to provide good cycle life at room temperature and high temperatures and outstanding safety with increased capacity.

In general, the fundamental requirements for a battery are high capacity, good cycle life at high temperature, good cycle life at room temperature, and high safety at penetration and overcharge. A great deal of research on developing a battery satisfying these requirements has been performed, but the conventional arts have been shown to be limited in these respects.

LiCoO₂ is widely used as a positive active material because of its high capacity. However, LiCoO₂ is expensive and while it has high capacity, there is an ever-increasing need for batteries with even higher capacity. Recently, research has sharply turned toward nickel-based positive active materials with more theoretical capacity than LiCoO₂.

However, Ni-based positive active materials consisting of nickel and lithium, such as LiNiO₂, exhibit poor cycle life characteristics. In order to improve cycle life characteristics, the present invention provides a positive active material comprising a first active material represented by either or both of formulas 1 and 2, which are obtained from partial substitution of nickel with cobalt or manganese by adding small amounts of cobalt or manganese.
LiₐNi_{b}Mn_{c}M_{d}O₂ (1)
where 0.90≦a≦1.2; 0.5≦b≦0.9; 0<c<0.4; and 0≦d≦0.2; and preferably d is 0.001≦d≦0.2; and M is at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po.
LiₐNi_{b}Co_{c}Mn_{d1}MₑO₂ (2)
where 0.90≦a≦1.2; 0.5≦b≦0.9; 0<c<0.4; 0 <d1<0.4; and 0≦e≦0.2 and preferably 0.001≦e≦0.2; and M is at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po.

The Ni-based first active material has higher theoretically capacity, but it has a spherical shape which results in reduced density of the active mass which includes an active material, a binder and a conductive agent formed on a current collector. Therefore, the substantial capacity of the Ni-based first active material is lower than the theoretical capacity. Thus, in the present invention, the positive active material also includes a second active material represented by Formula 3 in order to increase capacity.
LiₐCOM_{b1}O₂ (3)
where: 0.90≦a≦1.2; and 0≦b1<0.2; and preferably b1 is in the range of 0.001≦b1≦0.2; and M is at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po.

The active mass density of the electrode is determined by dividing the total mass of all the components other than a current collector (i.e. an active material, a conductor, and a binder) in the electrode by their volume. A low active mass density results in a low capacity in the battery because of the decrease of the amount of active material per unit of volume (i.e. per unit of thickness, assuming the area of the electrode is constant). That is to say, the positive active material represented by either or both of Formulas 1 and 2 in the present invention cannot establish high capacity characteristics alone, but can only accomplish a capacity similar to that of LiCoO₂ due to the low active mass density despite the high theoretical capacity.

Therefore, another positive active material represented by Formula 3 is introduced to solve the aforementioned problem by increasing the active mass density. Cooperating with the first one, the second positive active material can successfully contribute to providing a battery with high cycle life at both normal and high temperatures, and with excellent safety.

Exemplary of the first positive active materials are LiNi_{0.8}Co_{0.1}Mn_{0.1}O₂, LiNi_{0.8}Co_{0.15}Mn_{0.05}O₂, LiNi_{0.8}Co_{0.05}Mn_{0.15}O₂, LiNi_{0.7}Co_{0.1}Mn_{0.2}O₂, LiNi_{0.7}Co_{0.2}Mn_{0.1}O₂, LiNi_{0.7}Co_{0.15}Mn_{0.15}O₂, LiNi_{0.7}Co_{0.05}Mn_{0.25}O₂, LiNi_{0.7}Co_{0.25}Mn_{0.05}O₂, LiNi_{0.6}Co_{0.03}Mn_{0.1}O₂, LiNi_{0.6}Co_{0.2}Mn_{0.2}O₂, LiNi_{0.6}Co_{0.1}Mn_{0.3}O₂, LiNi_{0.8}Mn_{0.2}O₂, LiNi_{0.7}Mn_{0.3}O₂, or LiNi_{0.6}Mn_{0.4}O₂. In one embodiment, the second positive active material is preferably LiCoO₂. That is, it is preferable to use a mixture of the LiCoO₂ second positive active material and one of the first active materials selected from LiNi_{0.8}Co_{0.1}Mn_{0.1}O₂, LiNi_{0.8}Co_{0.15}Mn_{0.05}O₂, LiNi_{0.8}Co_{0.05}Mn_{0.15}O₂, LiNi_{0.7}Co_{0.1}Mn_{0.2}O₂, LiNi_{0.7}Co_{0.2}Mn_{0.1}O₂, LiNi_{0.7}Co_{0.15}Mn_{0.15}O₂, LiNi_{0.7}Co_{0.05}Mn_{0.25}O₂, LiNi_{0.7}Co_{0.25}Mn_{0.05}O₂, LiNi_{0.6}Co_{0.03}Mn_{0.1}O₂, LiNi_{0.6}Co_{0.2}Mn_{0.2}O₂, LiNi_{0.6}Co_{0.1}Mn_{0.3}O₂, LiNi_{0.8}Mn_{0.2}O₂, LiNi_{0.7}Mn_{0.3}O₂, or LiNi_{0.6}Mn_{0.4}O₂ LiCo₂.

The synergistic effect of the present invention illustrated above can be obtained only when the mixture of the aforementioned first and second positive active materials is used. No other active material with a particle shape similar to that of the second positive active material can obtain the same synergistic effect unless it is represented by Formula 3. Furthermore, the synergistic effect can be maximized only when the two materials are mixed in the appropriate proportion. The weight ratio of the first material to the second material in the mixture is preferably from 90:10 to 30:70, and more preferably from 90:10 to 40:60.

U.S. Pat. No. 6,379,842 discloses the use of a physical mixture of LiₓNi_{y}Co_{z}MₙO₂ where 0≦x≦1, y+z+n=1, 0≦n≦0.25, 0≦y, 0≦z, 0≦z/y≦⅓, and M is one selected from Al, Ti, W, Cr, Mo, Mg, Ta, Si, and mixtures thereof; and LiₓMn₂₋ᵣM1ᵣO₄ where 0≦x≦1 and M1 is an element selected from Cr, Ti, W, Ni, Co, Fe, Sn, Zn, Zr, Si, and mixtures thereof, as a positive active material, but it failed in establishing good cycle life at a high temperature. The mixed positive active material of the present invention is not only different from that of the U.S. patent, but it also succeeds in establishing improved cycle life at a high temperature. Therefore, it is well understood that the present invention cannot easily be derived from the U.S. patent.

U.S. Pat. No. 5,429,890 discloses the use of the mixed positive active material of LiₓMn₂O₄ (where 0<x≦2) and either of LiₓNiO₂ (where 0<x≦2) and LiₓCoO₂ (where 0<x≦2). Here, LiₓMn₂O₄ (0<x≦2) was used as a main material and either of LiₓNiO₂ (where 0<x≦2) and LiₓCoO₂ (where 0<x≦2) was blended into the main material. However, this positive active material also did not succeed in establishing good cycle life at a high temperature. Therefore, the present invention is not anticipated and is not obvious over the above U.S. patent, which can be understood by a skilled person in the related art. Additionally, in the above U.S. Patent, LiₓMn₂O₄ and either of LiₓNiO₂ and LiₓCoO₂ are mixed with the ratio nearly approaching 1:1. LiₓMn₂O₄ was present in a relatively excessive amount of the LiₓMn₂O₄, which resulted in the decreased battery capacity and cycle life at high temperature due to the low intrinsic capacity of LiₓMn₂O₄.

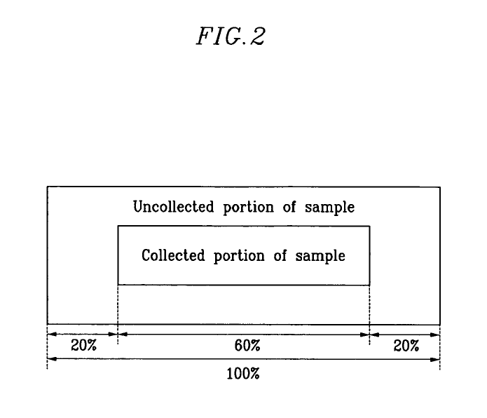

The present invention includes a mixture of two different materials in preparing a positive active material to fabricate an improved battery. The positive active material of the present invention including the first and the second active materials is identified by the SEM-EDX measurements, after the battery is charged and discharged (battery performance measurements). The SEM-EDX was measured on the sample collected from a central portion, as shown in FIG. 2, after the charged and discharged battery is disassembled and is pre-treated, because the surface properties of the electrodes can be transformed depending on which a part of an electrode is selected (for example, the edge or the folded part of the electrode). That is, the SEM-EDX analysis was performed for the central 60% of an electrode, excluding 20% of each edge in length and 20% of each edge in width. In addition, folded parts in the winding, even though they belong to the selected central 60% part, were excluded. A small chip of 1 to 5 cm in width and 1 to 53 cm in length was sampled from the central 60% part of an electrode. This sample was dipped in a dimethyl carbonate solvent for a predetermined time, and dried at a temperature of 40° C. at a vacuum pressure of 10.0 torr to 1×10⁻⁶ torr for an hour before the SEM-EDX measurement.

The charge and discharge were performed under the conditions called formation operation and standard operation in the related art. That is, the charge and the discharge are preferably performed at a charging rate between 0.1 and 2.0 C and more preferably between 0.2 and 1.5 C, and preferably a discharging rate between 0.1 to 2.0 C, and more preferably between 0.2 and 1.5 C. The charge current density is 0.1 to 5.0 mA/cm³ based on area, and preferably 0.2 to 4.0 mA/cm³, and the discharge current density is 0.1 to 5.0 mA/cm³ based on area, and more preferably 0.2 to 4.0 mA/cm³. The charge and the discharge cycles are preferably performed from 1 to 300 times, and more preferably from 1 to 99 times. A battery is presented in the condition of a charged or discharged state, or in a state of being charged and being discharged after the charging and the discharging. Furthermore, the battery has an OCV (open circuit voltage) of 1.0 to 5.5V and more preferably 1.5 to 4.5V after the charging and the discharging.

The positive electrode of the present invention generally includes a conductive agent used to impart conductivity on a positive electrode in addition to the first and second positive active materials. For the conductive agent, any material used as a conductive agent in a lithium secondary battery can be used, for example, carbon black, carbon nanotubes, carbon fiber, graphite, graphite fiber, or a conductive polymer such as polyanilline, polythiophene, and polypyrrole, or a metal powder or metal fiber such as copper, nickel, aluminum, and similar materaials.

In addition, a positive electrode of the present invention includes a binder to adhere the particles of a positive active material to one another and to the current collector. For the binder, any material normally used to fabricate a lithium secondary battery can be used. Examples include styrene-butadiene rubber, polyvinylalcohol, carboxylmethylcellulose, hydroxypropylenecellulose, diacetylenecellulose, polyvinylchloride, polyvinylpyrrolidone, polytetrafluoroethylene, polyvinyllidenefluoride, polyethylene, polypropylene, and similar materials.

A negative electrode of the present invention includes a negative active material which is capable of reversibly intercalating and deintercalating lithium ions. Either crystalline or amorphous carbon-based materials can be used as the negative active material. In one embodiment, the preferred negative active material is crystalline carbon with Lc (crystallite size) of at least 20 nm in X-ray diffraction and exhibiting an exothermic peak at 700° C. or more. Suitable crystalline carbon includes carbonaceous material prepared by carbonizing meso-phase spherical particles and graphitizing the carbonized material, or graphite fiber prepared by carbonizing meso-phase pitch fiber and graphitizing the carbonized material.

The rechargeable lithium battery of the present invention also includes an electrolyte including a non-aqueous organic solvent and a lithium salt. The lithium salt is dissolved in the organic solvent to act as a lithium-ion supporting source, which helps to allow the operation of the battery and facilitate the transfer of lithium ions. Suitable lithium salts include electrolytic salts supporting one or two materials such as those selected from the group consisting of: LiPF₆, LiBF₄, LiSbF₆, LiAsF₆, LiCF₃SO₃, LiN(CF₃SO₂)₃, Li(CF₃SO₂)₂N, LiC₄F₉SO₃, LiClO₄, LiAlO₄, LiAlCl₄, LiN(CₓF₂ₓ₊₁SO₂)(CₓF_{2y+1}SO₂)(wherein x are y are natural numbers.), LiCl, Lil, and lithium bisoxalate borate. The concentration of the lithium salt is suitably in the range of 0.1 to 2.0M. When the lithium salt concentration is under 0.1M, the conductivity of electrolyte decreases and thus the performance of the electrolyte deteriorates. When the concentration of the lithium salt is over 2.0M, the viscosity of electrolyte increases, resulting in reduced movement of lithium ions.

The non-aqueous organic solvent acts as a medium which can transport ions that participate in the electrochemical reactions. The non-aqueous organic solvent includes one or more solvents selected from benzene, toluene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, R—CN (where R is a hydrocarbon with from 2 to 50 carbons, and can be linear, branched, or cyclic, and may include double bonds, aromatic rings, or ether groups), dimethylformamide, dimethylacetate, xylene, cyclohexane, tetrahydrofuran, 2-methyltetrahydrofuran, cyclohexanone, ethanol, isopropyl alcohol, dimethyl carbonate, ethylmethyl carbonate, diethyl carbonate, methylpropyl carbonate, methyl propionate, ethyl propionate, methyl acetate, ethyl acetate, propyl acetate, dimethoxyethane, 1,3-dioxolane, diglyme, tetraglyme, ethylene carbonate, propylene carbonate, γ-butyrolactone, sulfolane, valerolactone, decanolide, mevalolactone and mixtures thereof. When using a mixture of more than one of the aforementioned organic solvents, the mixing ratio can be appropriately regulated depending on the intended capacity of a battery, which is comprehensively understood by a skilled person in the art.

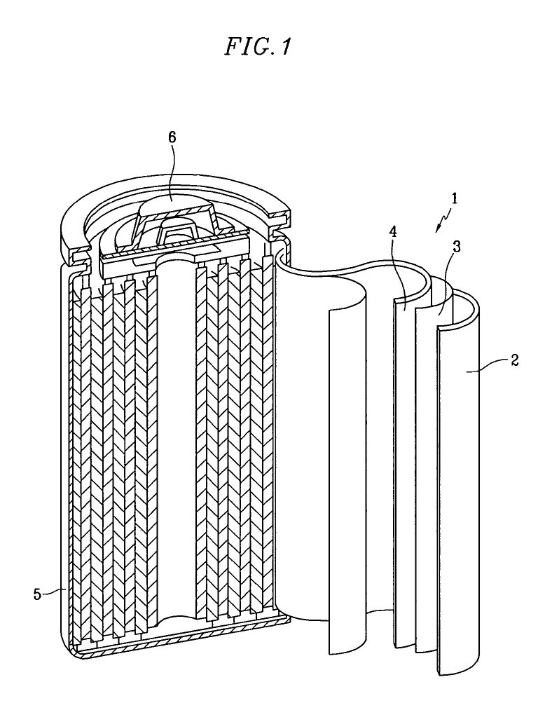

FIG. 1 shows one example of a lithium secondary battery constructed as illustrated above. A lithium secondary battery of the present invention as shown in FIG. 1 includes a positive electrode 3, a negative electrode 2, a separator 4 interposed between the positive electrode 3 and negative electrode 2, an electrolyte impregnated in the positive electrode 3, the negative electrode 2, and the separator 4, a cylindrical battery case 5, and a sealing member 6 to seal the case 5. FIG. 1 illustrates the structure of a cylindrical type of battery, but the present invention is not limited thereto, as it could be any shape such as a prismatic battery or a pouch.

The following examples illustrate the present invention in further detail. However, it is understood that the present invention is not limited by these examples.

### EXAMPLES 1 TO 16

Mixed positive active materials were prepared by using LiNi_{0.8}Mn_{0.2}O₂, or LiNi_{0.8}Co_{0.1}Mn_{0.1}O₂ as a first positive active material, and LiCoO₂ as a second positive active material according to the composition ratios shown in Table 1. Then, a positive active material slurry was prepared in the weight ratio 94:3:3 of the mixed positive active material, polyvinylidene fluoride as a binder, and super-P as a conductive agent in an N-methyl pyrrolidone solvent. Next, the slurry was coated on an aluminum current collector, and then a positive electrode was fabricated by compressing it after drying.

### COMPARATIVE EXAMPLES 1 TO 7

Positive electrodes were prepared according to the same method as in Example 1, except that LiCoO₂, LiNiO₂, LiMn₂O₄, LiNi_{0.8}Co_{0.2}O₂, LiNi_{0.8}Co_{0.2}O₂, LiCo_{0.8}Mn_{0.2}O₂, and LiNi_{0.8}Co_{0.1}Mn_{0.1}O₂ alone were used as the positive active materials as shown in Table 1.

### COMPARATIVE EXAMPLES 8 TO 27

Positive electrodes were prepared according to the same method as in Example 1, except that LiCoO₂, LiNiO₂, LiNi_{0.8}Co_{0.2}, and LiNi_{0.8}Mn_{0.2}O₂ were used as the first positive active materials and LiMn₂O₄ or LiCoO₂ was used as a second positive active material as shown in Table 1.

Prismatic batteries with thicknesses of 46 mm, widths of 34 mm, and lengths of 50 mm were fabricated using each positive electrode prepared in Examples 1 to 16 and Comparative Examples 1 to 27 with a corresponding negative electrode. The negative electrode was prepared through drying and compressing a copper current collector coated with a slurry. The negative active material slurry was prepared by mixing a carbon negative active material and polyvinylidene fluoride as a binder in the weight ratio of 94/6 in N-methylpyrrolidene as a solvent. The electrolyte used was a mixed solvent of ethylene carbonate with 1.0M of LiPF₆ dissolved in dimethylcarbonate and ethylmethyl carbonate in the volume ratio of 3:3:4.

Evaluation of Battery Characteristics

Each fabricated battery was charged at 0.2 C and discharged at 0.2 C one time (FORMATION process), and also charged at 0.5 C and discharged at 0.2 C one time (STANDARD process). The amount of discharge at the first standard process was measured and is shown as capacity in Table 1.

In addition, the results of the cycle life test after 300 cycles at a room temperature with a charge of 1.0 C and discharge of 1.0 C are shown in Table 1. The results of high-temperature cycle life test after 300 cycles at 60° C. with a charge of 1.0 C and discharge of 1.0 C are also shown in Table 1. Furthermore, the results of two different penetration tests after charging a fabricated battery at 4.2V and after overcharging it at 4.35V are shown in Table 1. In Table 1, R.T indicates room temperature, and H.T indicates high temperature (60° C.).

TABLE 1

| | | | First: | | | | | | | | |
|---|---|---|---|---|---|---|---|---|---|---|---|
| | | | Second | | | | | | | | |
| | | | Mixing | | | | Increased | 300^{th} | | | |
| | | | Ratio | | Capacity | | Battery | Cycle Life | | | |
| | Positive Active Material | | (weight | | Positive | Battery | Capacity | | H.T | | Penetration at |
| Example | First | Second | ratio) | | (mAh/g) | (mAh) | (%) | R.T (%) | (%) | Penetration | Over-Charge |
| Comparative | LiCoO₂ | — | — | — | 140 | 780 | 0 | 86 | 83 | Non- | Non- |
| Example 1 | | | | | | | | | | combustion | combustion |
| Comparative | LiNiO₂ | — | — | — | 180 | 780 | 0 | 52 | 45 | Combustion | Combustion |
| Example 2 | | | | | | | | | | | |
| Comparative | LiMn₂O₄ | — | — | — | 100 | 700 | −10 | 87 | 30 | Non- | Non- |
| Example 3 | | | | | | | | | | combustion | combustion |
| Comparative | LiNi_{0.8}Co_{0.2}O₂ | — | — | — | 180 | 780 | 0 | 73 | 76 | Combustion | Combustion |
| Example 4 | | | | | | | | | | | |
| Comparative | LiNi_{0.8}Mn_{0.2}O₂ | — | — | — | 170 | 780 | 0 | 76 | 77 | Non- | Non- |
| Example 5 | | | | | | | | | | combustion | combustion |
| Comparative | LiCo_{0.8}Mn_{0.2}O₂ | — | — | — | 120 | 740 | −5 | 80 | 76 | Non- | Non- |
| Example 6 | | | | | | | | | | combustion | combustion |
| Comparative | LiNi_{0.8}Co_{0.1}Mn_{0.1}O₂ | — | — | — | 180 | 780 | 0 | 80 | 75 | Non- | Non- |
| Example 7 | | | | | | | | | | combustion | combustion |
| Comparative | LiCoO₂ | LiMn₂O₄ | 80 | 20 | 132 | 764 | −2 | 83 | 53 | Non- | Non- |
| Example 8 | | | | | | | | | | combustion | combustion |
| Comparative | LiNiO₂ | LiMn₂O₄ | 80 | 20 | 164 | 828 | 6 | 60 | 51 | Combustion | Combustion |
| Example 9 | | | | | | | | | | | |
| Comparative | LiNi_{0.8}Co_{0.2}O₂ | LiMn₂O₄ | 80 | 20 | 164 | 828 | 6 | 75 | 50 | Combustion | Combustion |
| Example 10 | | | | | | | | | | | |
| Comparative | LiNi_{0.8}Mn_{0.2}O₂ | LiMn₂O₄ | 80 | 20 | 164 | 828 | 6 | 73 | 48 | Non- | Non- |
| Example 11 | | | | | | | | | | combustion | combustion |
| Comparative | LiNiO₂ | LiCoO₂ | 90 | 10 | 176 | 852 | 9 | 53 | 50 | Combustion | Combustion |
| Example 12 | | | | | | | | | | | |
| Comparative | LiNiO₂ | LiCoO₂ | 80 | 20 | 172 | 844 | 8 | 55 | 54 | Combustion | Combustion |
| Example 13 | | | | | | | | | | | |
| Comparative | LiNiO₂ | LiCoO₂ | 70 | 30 | 168 | 836 | 7 | 59 | 58 | Combustion | Combustion |
| Example 14 | | | | | | | | | | | |
| Comparative | LiNiO₂ | LiCoO₂ | 60 | 40 | 164 | 828 | 6 | 62 | 60 | Combustion | Combustion |
| Example 15 | | | | | | | | | | | |
| Comparative | LiNiO₂ | LiCoO₂ | 50 | 50 | 160 | 820 | 5 | 67 | 66 | Combustion | Combustion |
| Example 16 | | | | | | | | | | | |
| Comparative | LiNiO₂ | LiCoO₂ | 40 | 60 | 156 | 812 | 4 | 70 | 69 | Combustion | Non- |
| Example 17 | | | | | | | | | | | combustion |
| Comparative | LiNiO₂ | LiCoO₂ | 30 | 70 | 152 | 804 | 3 | 76 | 74 | Combustion | Non- |
| Example 18 | | | | | | | | | | | combustion |
| Comparative | LiNiO₂ | LiCoO₂ | 20 | 80 | 148 | 796 | 2 | 82 | 77 | Non- | Non- |
| Example 19 | | | | | | | | | | combustion | combustion |
| Comparative | LiNi_{0.8}Co_{0.2}O₂ | LiCoO₂ | 90 | 10 | 176 | 852 | 9 | 74 | 70 | Combustion | Combustion |
| Example 20 | | | | | | | | | | | |
| Comparative | LiNi_{0.8}Co_{0.2}O₂ | LiCoO₂ | 80 | 20 | 172 | 844 | 8 | 75 | 72 | Combustion | Combustion |
| Example 21 | | | | | | | | | | | |
| | | | First: | | | | | | | | |
| | | | Second | | Capacity | | | | | | |
| | | | Mixing | | Positive | | Increased | 300^{th} | | | |
| | | | Ratio | | Active | | Battery | Cycle Life | | | |
| | Positive Active Material | | (weight | | material | Battery | Capacity | | H.T | | Penetration at |
| Example | First | Second | ratio) | | (mAh/g) | (mAh) | (%) | R.T (%) | (%) | Penetration | Over-Charge |
| Comparative | LiNi_{0.8}Co_{0.2}O₂ | LiCoO₂ | 70 | 30 | 168 | 836 | 7 | 75 | 71 | Combustion | Combustion |
| Example 22 | | | | | | | | | | | |
| Comparative | LiNi_{0.8}Co_{0.2}O₂ | LiCoO₂ | 60 | 40 | 164 | 828 | 6 | 76 | 72 | Combustion | Combustion |
| Example 23 | | | | | | | | | | | |
| Comparative | LiNi_{0.8}Co_{0.2}O₂ | LiCoO₂ | 50 | 50 | 160 | 820 | 5 | 79 | 73 | Combustion | Combustion |
| Example 24 | | | | | | | | | | | |
| Comparative | LiNi_{0.8}Co_{0.2}O₂ | LiCoO₂ | 40 | 60 | 156 | 812 | 4 | 81 | 75 | Combustion | Non- |
| Example 25 | | | | | | | | | | | combustion |
| Comparative | LiNi_{0.8}Co_{0.2}O₂ | LiCoO₂ | 30 | 70 | 152 | 804 | 3 | 82 | 78 | Combustion | Non- |
| Example 26 | | | | | | | | | | | combustion |
| Comparative | LiNi_{0.8}Co_{0.2}O₂ | LiCoO₂ | 20 | 80 | 148 | 796 | 2 | 74 | 80 | Non- | Non- |
| Example 27 | | | | | | | | | | combustion | combustion |
| Example 1 | LiNi_{0.8}Mn_{0.2}O₂ | LiCoO₂ | 90 | 10 | 167 | 834 | 7 | 75 | 71 | Non- | Non- |
| | | | | | | | | | | combustion | combustion |
| Example 2 | LiNi_{0.8}Mn_{0.2}O₂ | LiCoO₂ | 80 | 20 | 164 | 828 | 6 | 75 | 73 | Non- | Non- |
| | | | | | | | | | | combustion | combustion |
| Example 3 | LiNi_{0.8}Mn_{0.2}O₂ | LiCoO₂ | 70 | 30 | 161 | 822 | 5 | 77 | 73 | Non- | Non- |
| | | | | | | | | | | combustion | combustion |
| Example 4 | LiNi_{0.8}Mn_{0.2}O₂ | LiCoO₂ | 60 | 40 | 158 | 816 | 5 | 78 | 74 | Non- | Non- |
| | | | | | | | | | | combustion | combustion |
| Example 5 | LiNi_{0.8}Mn_{0.2}O₂ | LiCoO₂ | 50 | 50 | 155 | 810 | 4 | 79 | 75 | Non- | Non- |
| | | | | | | | | | | combustion | combustion |
| Example 6 | LiNi_{0.8}Mn_{0.2}O₂ | LiCoO₂ | 40 | 60 | 152 | 804 | 3 | 80 | 76 | Non- | Non- |
| | | | | | | | | | | combustion | combustion |
| Example 7 | LiNi_{0.8}Mn_{0.2}O₂ | LiCoO₂ | 30 | 70 | 149 | 798 | 2 | 81 | 78 | Non- | Non- |
| | | | | | | | | | | combustion | combustion |
| Example 8 | LiNi_{0.8}Mn_{0.2}O₂ | LiCoO₂ | 20 | 80 | 146 | 792 | 2 | 75 | 80 | Non- | Non- |
| | | | | | | | | | | combustion | combustion |
| Example 9 | LiNi_{0.8}Co_{0.1}Mn_{0.1}O₂ | LiCoO₂ | 90 | 10 | 176 | 852 | 9 | 76 | 71 | Non- | Non- |
| | | | | | | | | | | combustion | combustion |
| Example 10 | LiNi_{0.8}Co_{0.1}Mn_{0.1}O₂ | LiCoO₂ | 80 | 20 | 172 | 844 | 8 | 76 | 72 | Non- | Non- |
| | | | | | | | | | | combustion | combustion |
| Example 11 | LiNi_{0.8}Co_{0.1}Mn_{0.1}O₂ | LiCoO₂ | 70 | 30 | 168 | 836 | 7 | 77 | 73 | Non- | Non- |
| | | | | | | | | | | combustion | combustion |
| Example 12 | LiNi_{0.8}Co_{0.1}Mn_{0.1}O₂ | LiCoO₂ | 60 | 40 | 164 | 828 | 6 | 78 | 74 | Non- | Non- |
| | | | | | | | | | | combustion | combustion |
| Example 13 | LiNi_{0.8}Co_{0.1}Mn_{0.1}O₂ | LiCoO₂ | 50 | 50 | 160 | 820 | 5 | 78 | 76 | Non- | Non- |
| | | | | | | | | | | combustion | combustion |
| Example 14 | LiNi_{0.8}Co_{0.1}Mn_{0.1}O₂ | LiCoO₂ | 40 | 60 | 156 | 812 | 4 | 80 | 78 | Non- | Non- |
| | | | | | | | | | | combustion | combustion |
| Example 15 | LiNi_{0.8}Co_{0.1}Mn_{0.1}O₂ | LiCoO₂ | 30 | 70 | 152 | 804 | 3 | 82 | 79 | Non- | Non- |
| | | | | | | | | | | combustion | combustion |
| Example 16 | LiNi_{0.8}Co_{0.1}Mn_{0.1}O₂ | LiCoO₂ | 20 | 80 | 148 | 796 | 2 | 85 | 81 | Non- | Non- |
| | | | | | | | | | | combustion | combustion |

As shown in Table 1, each cell prepared using LiNi_{0.8}MnO₂ or LiNi_{0.8}Co_{0.1}Mn_{0.1}O₂ as the first positive active material and LiCoO₂ as the second positive active material according to Examples 1 to 16 maintained a capacity of over 70% in the cycle life test after 300 cycles at room and high temperatures, and also proved excellent in positive active material capacity and battery capacity. Likewise, each cell in Examples 1 to 16 was established to be safe, because it did not combust on the tests of penetration and overcharge. Therefore, from the test results, the cells in Examples 1 to 16 proved excellent in safety and cycle life characteristics at the high and normal temperature.

In addition, all cells in the above Examples showed over 70% of cycle life at room and high temperature and safety from combustion in penetration after normal charge and penetration after overcharge. In terms of capacities, the cells including positive active materials that were prepared by mixing the first and the second positive active materials in a weight ratio of 90:10 to 50:50 according to Examples 1 to 5 and 9 to 13 turned out to be outstanding, but cells with the best capacities in the present invention turned out to be the cells according to Examples 1 to 3 and 9 to 11, including positive active materials that were prepared by mixing the first and the second positive active materials in a weight ratio of between 90:10 and 70:30.

In contrast, a cell fabricated with only LiCoO₂ as a positive active material according to Comparative Example 1 exhibited a lower positive active material capacity and also a lower battery capacity than those of Examples 1 to 16. Likewise, a cell fabricated with only LiCoO₂ with a high positive active material capacity as a positive active material according to Comparative Example 2 exhibited a decreased cycle life of up to 52% and 45%, and also did not exhibit the desired safety as it combusted in the test of penetration after normal charge and penetration after overcharge. Another cell fabricated with only LiMn₂O₄ as a positive active material according to Comparative Example 3 did not prove to perform well for positive active material capacity, battery capacity, and cycle life at the high temperature.

Furthermore, compared with the cell fabricated with LiCoO₂ according to Example 3, a cell fabricated by using LiNi_{0.8}Co_{0.2}O₂ prepared by substituting a part of Ni with Co in LiNiO₂ to improve capacity and cycle life according to Comparative Example 4 as a positive active material did not show increased battery capacity, it only showed increased positive active material capacity, and it also did not establish safety, combusting in the test of penetration after normal charge and penetration after overcharge. The reason why a cell fabricated with LiNi_{0.8}Co_{0.2}O₂ showed only an increase in positive active material capacity but not in battery capacity is that the positive active material did not establish a higher active mass density in an electrode prepared with the material. The same results were found in Comparative Examples 5 to 7 wherein a positive active material prepared by replacing a part of Ni in LiNiO₂ with Mn or Co and Mn was used. That is to say, cells in these Examples have no advantage in battery capacity despite an increase in positive active material capacity itself, because their battery capacities remain only at the same level as that of LiCoO₂ in Comparative Example 1 due to their lower active mass density of 3.3 g/cc in the electrodes than that of 3.65 g/cc in the one with LiCoO₂. Comparative Example 6 using LiCo_{0.8}Mn_{0.2}O₂ where a part of Co in LiCoO₂ was replaced with Mn was used as a positive active material, resulted in a battery with decreased positive active material and battery capacity compared with those of Comparative Example 1.

In addition, for Comparative Example 8 where a mixture of LiCoO₂ and LiMn₂O₄ was used, the resulting battery had lower battery capacity than that with LiCoO₂ alone. Comparative Example 9 which used a mixture of LiNiO₂ and LiMn₂O₄ resulted in a cell with higher battery capacity than that with LiCoO₂ but the battery secured only 60 and 51% of cycle life rating at the normal and high temperatures respectively, and it also did not establish safety, combusting in the tests of penetration after normal charge and penetration after overcharge. Likewise, Comparative Examples 10 to 11 wherein LiMn₂O₄ was mixed with the materials with layered structures such as LiNi_{0.8}Mn_{0.2}O₂ and LiNi_{0.8}Co_{0.1}Mn_{0.1}O₂, resulted in cells with increased battery capacity and positive active material capacity compared with the ones of Comparative Examples 8 to 9, but they failed in establishing good cycle life characteristics at the normal and high temperatures, and in terms of safety in that they combusted in the tests of penetration after normal charge and penetration after overcharge.

Results of the Electrode Analysis

SEM-EDX analysis was performed on both of the electrodes of the cell fabricated according to Example 12, which were dissembled after the formation and standard evaluations. A part of the electrode for the SEM-EDX analysis was sampled, as shown in FIG. 2, because the surface properties of the electrode could be changed depending on the structure of the electrode (the edge or the folded part) after assembling the battery, i.e. the core 60% part of the electrode was sampled for the SEM-EDX analysis, excluding 20% of each of four edges in width and length from 100% of the given electrode. In addition, the folded part in winding was also excluded, even though it belonged to the sampled central 60% part.

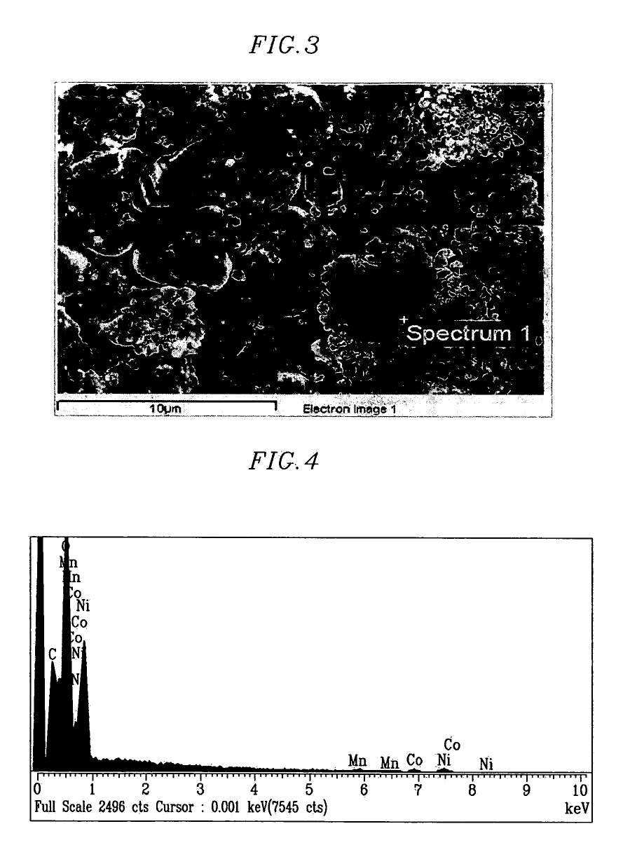

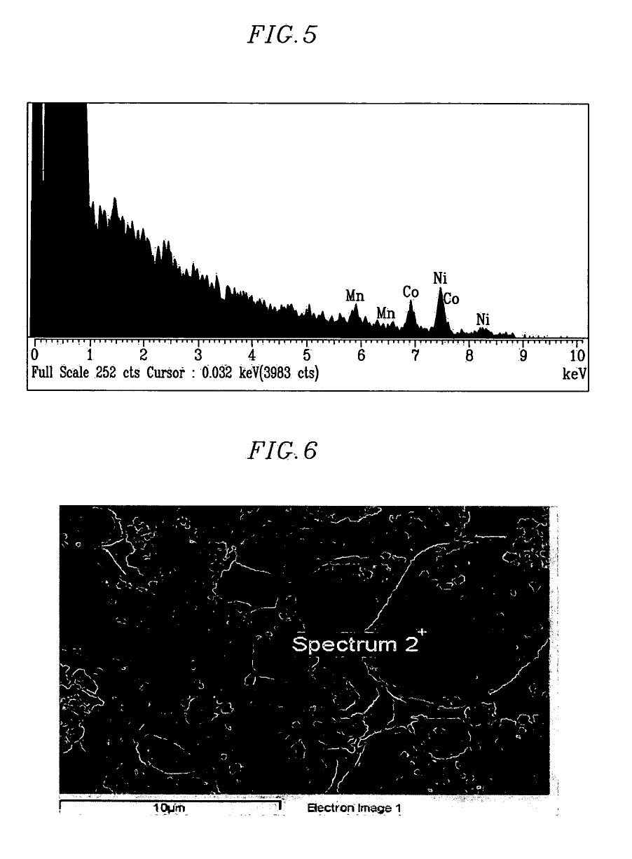

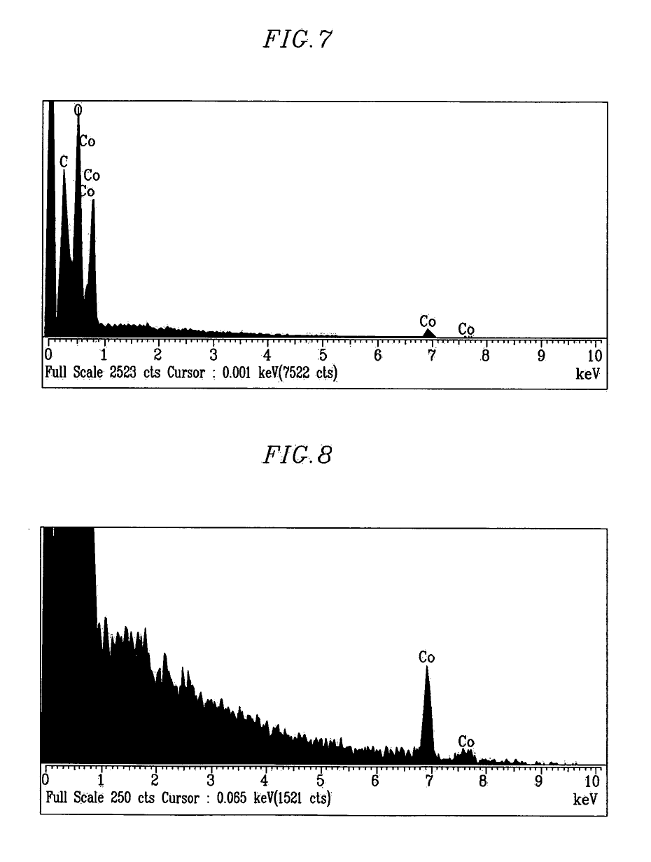

A part of the electrode measuring 5 cm long and 3 cm wide was sampled again from the central 60% part of the electrode and dipped in 150 ml of dimethyl carbonate solvent contained in a 200 ml beaker for 5 minutes. Then, the electrode sample was dried under a vacuum pressure of 1×10⁻⁴ torr at the temperature of 40° C. for an hour, before the SEM-EDX was measured. FIG. 3 is a SEM picture emphasizing the first positive active material of LiNi_{0.8}Co_{0.1}Mn_{0.1}O₂, and FIG. 6 is a SEM picture emphasizing the second positive active material of LiCoO₂. The unbroken part in FIG. 3 is the second positive active material and the broken part in FIG. 6 is the first positive active material. In addition. FIGS. 4 and 5 illustrate the EDX results of the part of the first positive active material of LiNiO₈Co_{0.1}Mn_{0.1}O₂, while FIGS. 7 and 8 illustrate the EDX results of the part of the second positive active material of LiCoO₂.

On the other hand, FIGS. 3 and 6 show that LiNi_{0.8}Co_{0.1}Mn_{0.1}O₂ and LiCoO₂ in both of the electrodes were mixed in a different shape from those of FIGS. 4, 5, 7, and 8, i.e. LiCoO₂ keeps a big chunk particle shape and LiNi_{0.8}Co_{0.1}Mn_{0.1}O₂ shows a pressed and broken particle shape from the compression. The LiNi_{0.8}Co_{0.1}Mn_{0.1}O₂ is composed of secondary particles which are formed by agglomeration of primary particles of 1-2 μm, and therefore these secondary particles were pressed and broken in the compression of the electrodes. An analysis of the pressed part revealed three components of Ni, Co, and Mn, shown in FIGS. 4 and 5. On the other hand, the analysis of LiCoO₂ particles revealed only Co since LiCoO₂ keeps its shape after the compression (FIGS. 7 and 8). Therefore, the SEM-EDX result of the electrode shows the components of the mixed active material.

In conclusion, a lithium secondary battery of the present invention using a positive active material formed by mixing nickel-based and cobalt-based compounds in the appropriate proportion increased the capacity by 2 to 9%, and also established good cycle life at the normal and high temperature, and good safety in the tests of penetration after normal charge and penetration after overcharge.

The present invention has been described in detail with reference to certain preferred embodiments. It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A lithium secondary battery comprising:
a positive electrode comprising a first positive active material represented by one or both of Formulas 1 and 2, and a second positive active material represented by Formula 3:
LiₐNi_{b}Mn_{c}M_{d}O₂ (Formula 1)
where 0.90≦a≦1.2, 0.5≦b≦0.9, 0<c<0.4, and 0≦d≦0.2, and M is at least element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po;
LiₐNi_{b}Co_{c}Mn_{d1}MₑO₂ (Formula 2)
where 0.90≦a≦1.2, 0.5≦b≦0.9, 0<c<0.4, 0<d1<0.4, and 0≦e≦0.2, and M is at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po;
LiₐCoM_{b1}O₂ (Formula 3)
where 0.90≦a≦1.2 and 0≦b1≦0.2, and M is at least one element selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Tl, Si, Ge, Sn, P, As, Sb, Bi, S, Se, Te, and Po;
a negative electrode comprising a negative active material; and
an electrolyte.

2. The lithium secondary battery according to claim 1, wherein the first positive active material and the second positive active material are mixed in a weight ratio from 90:10 to 30:70.

3. The lithium secondary battery according to claim 2, wherein the first positive active material and the second positive active material are mixed in a weight ratio from 90:10 to 40:60.

4. The lithium secondary battery according to claim 1, wherein the first positive active material is selected from the group consisting of LiNi_{0.8}Co_{0.1}Mn_{0.1}O₂, LiNi_{0.8}Co_{0.15}Mn_{0.05}O₂, LiNi_{0.8}Co_{0.05}Mn_{0.15}O₂, LiNi_{0.7}Co_{0.1}Mn_{0.2}O₂, LiNi_{0.7}Co_{0.2}Mn_{0.1}O₂, LiNi_{0.7}Co_{0.15}Mn_{0.15}O₂, LiNi_{0.7}Co_{0.05}Mn_{0.25}O₂, LiNi_{0.7}Co_{0.25}Mn_{0.05}O₂, LiNi_{0.6}Co_{0.3}Mn_{0.1}O₂, LiNi_{0.6}Co_{0.2}Mn_{0.2}O₂, LiNi_{0.6}Co_{0.1}Mn_{0.3}O₂, LiNi_{0.8}Mn_{0.2}O₂, LiNi_{0.7}Mn_{0.3}O₂, LiNi_{0.6}Mn_{0.4}O₂, and combinations thereof.

5. The lithium secondary battery according to claim 1, wherein the second positive active material is LiCoO₂.

6. The lithium secondary battery according to claim 1, wherein in Formula 1, 0.001≦d≦0.2.

7. The lithium secondary battery according to claim 1, wherein in Formula 2, 0.001≦e≦0.2.

8. The lithium secondary battery according to claim 1, wherein in Formula 3, 0.001≦b1≦0.2.

9. The lithium secondary battery according to claim 1, wherein the negative active material is selected from the group consisting of graphitic carbonaceous material which is capable of reversibly intercalating and deintercalating lithium ions, lithium metal, a lithium-containing alloy, or a material which is capable of forming a lithium-containing compound.

10. The lithium secondary battery according to claim 9, wherein the graphitic carbonaceous material has an Lc (crystallite size) of at least 20 nm in X-ray diffraction and exhibits an exothermic peak at 700° C. or more.

11. The lithium secondary battery according to claim 9, wherein the graphitic carbonaceous material is either crystalline carbon material which is prepared by carbonizing meso-phase spherical particles and graphitizing the carbonized material, or a graphite fiber which is prepared by carbonizing meso-phase pitch fiber and graphitizing the carbonized material.

12. The lithium secondary battery according to claim 9, wherein the electrolyte comprises at least one organic solvent selected from the group consisting of benzene, toluene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, R—CN where R is a linear, branched, aromatic or cyclic hydrocarbon or ether with from 2 to 50 carbons, dimethylformamide, dimethylacetate, xylene, cyclohexane, tetrahydrofuran, 2-methyltetrahydrofuran, cyclohexanone, ethanol, isopropyl alcohol, dimethyl carbonate, ethylmethyl carbonate, diethyl carbonate, methylpropyl carbonate, methyl propionate, ethyl propionate, methyl acetate, ethyl acetate, propyl acetate, dimethoxyethane, 1,3-dioxolane, diglyme, tetraglyme, ethylene carbonate, propylene carbonate, γ-butyrolactone, sulfolane, valerolactone, decanolide, and mevalolactone.

13. The lithium secondary battery according to claim 1, wherein the electrolyte comprises at least one compound selected from the group consisting of lithium hexafluorophosphate (LiPF₆), lithium tetrafluoroborate (LiBF₄), lithium hexafluoroarsenate (LiAsF₆), lithium perchlorate (LiClO₄), lithium tricloromethanesulfonate (CF₃SO₃Li), lithium bis(trifluoromethyl)sulfonimide (LiN(SO₂CF₃)₂), lithium bis(perfluoroethylsulfonyl)imide (LiN(SO₂C₂F₅)₂), and lithium bisoxalate borate).

14. The lithium secondary battery according to claim 1, wherein the electrolyte comprises a supporting salt at a concentration of 0.1 to 2.0M.

15. The lithium secondary battery according to claim 1, wherein as a result of SEM-EDX measurement of the positive electrode dissembled after charging and discharging the battery, the first positive active material shows peaks of Ni, Co, and Mn, and the second positive active material shows a peak of Co, or the first positive active material shows peaks of Ni and Mn, and the second positive active material shows a peak of Co.

16. The lithium secondary battery according to claim 15, wherein the charging and the discharging is performed at a charge rate between 0.1 and 2.0 C and a discharge rate between 0.1 and 2.0 C.

17. The lithium secondary battery according to claim 16, wherein the charging and the discharging is performed at a charge rate between 0.2 and 1.5 C and a discharge rate between 0.2 and 1.5 C.

18. The lithium secondary battery according to claim 15, wherein the charging and the discharging is performed at a charge current density between 0.1 and 5.0 mA/cm³ and a discharge current density between 0.1 and 5.0 mA/cm³.

19. The lithium secondary battery according to claim 18, wherein the charging and the discharging is performed at a charge current density between 0.2 and 4.0 mA/cm³ and a discharge current density between 0.2 and 4.0 mA/cm³.

20. The lithium secondary battery according to claim 15, wherein the charging and the discharging is performed for 1 to 300 times.

21. The lithium secondary battery according to claim 20, wherein the charging and the discharging is performed for 1 to 99 times.

22. The lithium secondary battery according to claim 15, wherein the battery is in a charged or discharged condition after the battery is charged and discharged.

23. The lithium secondary battery according to claim 20, wherein the battery is in a condition of being charged or discharged after the battery is charged and discharged.

24. The lithium secondary battery according to claim 20, wherein the battery has an open circuit voltage (OCV) in the range of 1.0 to 5.5V after the battery is charged and discharged.

25. The lithium secondary battery according to claim 24, wherein the battery has an open circuit voltage (OCV) in the range of 1.5 to 4.5V after the battery is charged and discharged.
